(19) United States
(12) Patent Application Publication
(10) Pub. No.: US 2021/0075687 A1
(43) Pub. Date: Mar. 11, 2021

(54) COMMUNICATION APPARATUS, METHOD AND COMPUTER PROGRAM

(71) Applicant: Nokia Solutions and Networks Oy, Espoo (FI)

(72) Inventors: Junqing Lou, Zhejiang (CN); Dan Zhang, Zhejiang (CN)

(21) Appl. No.: 16/629,576

(22) PCT Filed: Jul. 17, 2017
(86) PCT No.: PCT/CN2017/093127

§ 371 Date: Jan. 9, 2020

(51) Int. Cl. H04L 12/24; H04W 24/06

(52) U.S. Cl. CPC H04L 41/145; H04W 24/06

(57) ABSTRACT

A method comprising: processing by a testing apparatus, one or more data packets using simulations of at least one of: at least one radio access point and at least one user equipment; and a core network, wherein the one or more data packets comprises at least one of: one or more data packet received from the network server apparatus; and one or more data packets to be transmitted to the network server apparatus.

### FIELD

This disclosure relates to a communication, apparatus, method and computer program.

### BACKGROUND

A communication system can be seen as a facility that enables communication between two or more devices such as user terminals, machine-like terminals, base stations and/or other nodes by providing communication channels for carrying information between the communicating devices. A communication system can be provided, for example, by means of a communication network and one or more compatible communication devices. The communication may comprise, for example, communication of data for carrying data for voice, electronic mail (email), text message, multimedia and/or content data communications and so on. Non-limiting examples of services provided include two-way or multi-way calls, data communication or multimedia services and access to a data network system, such as the Internet.

In a wireless system at least a part of communications occurs over wireless interfaces. Examples of wireless systems include public land mobile networks (PLMN), satellite based communication systems and different wireless local networks, for example wireless local area networks (WLAN). A local area wireless networking technology allowing devices to connect to a data network is known by the tradename WiFi (or Wi-Fi). WiFi is often used synonymously with WLAN. The wireless systems can be divided into cells, and are therefore often referred to as cellular systems. A base station provides at least one cell.

A user can access a communication system by means of an appropriate communication device or terminal capable of communicating with a base station. Hence nodes, like base stations, are often referred to as access points. A communication device of a user is often referred to as user equipment (UE). A communication device is provided with an appropriate signal receiving and transmitting apparatus for enabling communications, for example enabling communications with the base station and/or communications directly with other user devices. The communication device can communicate on appropriate channels, e.g. listen to a channel on which a station, for example, a base station of a cell, transmits.

A communication system and associated devices typically operate in accordance with a given standard or specification which sets out what the various entities associated with the system are permitted to do and how that should be achieved. Communication protocols and/or parameters which may be used for the connection are also typically defined. Non-limiting examples of standardised radio access technologies include GSM (Global System for Mobile), EDGE (Enhanced Data for GSM Evolution) Radio Access Networks (GERAN), Universal Terrestrial Radio Access Networks (UTRAN) and evolved UTRAN (E-UTRAN). An example communication system architecture is the long-term evolution (LTE) of the Universal Mobile Telecommunications System (UMTS) radio-access technology. The LTE is standardised by the third Generation Partnership Project (3GPP). The LTE employs the Evolved Universal Terrestrial Radio Access Network (E-UTRAN) access and a further development thereof which is sometimes referred to as LTE Advanced (LTE-A).

Wireless communication systems may make use of a network server apparatus, such as a cloud base transceiver station (Cloud BTS), for the sending and receiving of data to and from radio access points on the network, and the processing of data to be sent or received from the radio access points. A Cloud BTS may be used in cloud radio access networks, in which the protocol stack is executed at a cloud BTS. By moving the radio network controller to the cloud BTS, operators can protect their investments and benefit sooner from scalability across technologies. The Cloud BTS can be provided by large centralized data centres or smaller distributed sites, or a combination of both.

During testing of a network server apparatus it may be helpful to maximise the number of devices used in a test as well as maximising the throughput of traffic used in the tests. For example, in a radio network Cloud BTS product, a Cloud BTS server has high capacity and throughput compared to a conventional 4G BTS. A test tool is needed to achieve the maximum number of UE and peak throughput in capacity, performance and load testing, as well as in stability testing of a network server apparatus.

### SUMMARY OF THE INVENTION

According to a first aspect, there is provided a method comprising: processing by a testing apparatus, one or more data packets using simulations of at least one of: at least one radio access point and at least one user equipment; and a core network, wherein the one or more data packets comprises at least one of: one or more data packet received from the network server apparatus; and one or more data packets to be transmitted to the network server apparatus.

In one embodiment, the network server apparatus is part of a base transceiver station server.

In one embodiment, the testing apparatus is part of the base transceiver station server.

In one embodiment, the processing of the one or more data packets comprises protocol processing the one or more data packets.

In one embodiment, the protocol processing of the one or more data packets comprises protocol processing using a protocol stack of the simulation of at least one radio access point and a protocol stack of the simulation of at least one user equipment.

In one embodiment, at least one of the protocol stacks does not perform processing for the data packets at one or more layers that are present in the protocol stacks of a real user equipment and a real radio access point.

In one embodiment, at least one of the protocol stacks does not perform processing for the data packets at least one of: a Packet data convergence protocol layer; a user data layer; a medium access control layer; a physical layer; and a radio frequency layer.

In one embodiment, the protocol stack of the simulation of at least one radio access node performs at least some of the processing performed by a protocol stack of a real user equipment instead of the protocol stack of the simulation of the user equipment.

In one embodiment, the at least some of the processing performed by a protocol stack of a real user equipment comprises radio link control layer processing.

In one embodiment, the testing apparatus comprises a simulation of: at least one radio access point and at least one user equipment; and a core network.

In one embodiment, the processing data packets using the simulation comprises processing user plane traffic at the simulation of the at least one radio access point but not the simulation of the at least one user equipment.

In one embodiment, the method comprises: prior to the processing of the one or more data packets receiving the one or more data packets from the network server apparatus.

In one embodiment, the method comprises: following the processing of the one or more data packets, sending the one or more data packets to the network server apparatus.

In one embodiment, the method comprises: processing by the testing apparatus, the one or more data packets using simulations of a plurality of radio access point and a plurality of user equipments.

According to a second aspect, there is provided a computer program comprising instructions such that when the computer program is executed on a computing device, the computing device is arranged to perform the steps of any embodiment of the first aspect.

According to a third aspect, there is provided an apparatus comprising: at least one processor and at least one memory including computer program code, the at least one memory and the computer program code configured to, with the at least one processor, cause the apparatus at least to: process by a testing apparatus, one or more data packets using simulations of at least one of: at least one radio access point and at least one user equipment; and a core network, wherein the one or more data packets comprises at least one of: one or more data packet received from the network server apparatus; and one or more data packets to be transmitted to the network server apparatus.

In one embodiment, the network server apparatus is part of a base transceiver station server.

In one embodiment, the testing apparatus is part of the base transceiver station server.

In one embodiment, the processing of the one or more data packets comprises protocol processing the one or more data packets.

In one embodiment, the protocol processing of the one or more data packets comprises protocol processing using a protocol stack of the simulation of at least one radio access point and a protocol stack of the simulation of at least one user equipment.

In one embodiment, at least one of the protocol stacks does not perform processing for the data packets at one or more layers that are present in the protocol stacks of a real user equipment and a real radio access point.

In one embodiment, at least one of the protocol stacks does not perform processing for the data packets at least one of: a Packet data convergence protocol layer; a user data layer; a medium access control layer; a physical layer; and a radio frequency layer.

In one embodiment, the protocol stack of the simulation of at least one radio access node performs at least some of the processing performed by a protocol stack of a real user equipment instead of the protocol stack of the simulation of the user equipment.

In one embodiment, the at least some of the processing performed by a protocol stack of a real user equipment comprises radio link control layer processing.

In one embodiment, the testing apparatus comprises a simulation of: at least one radio access point and at least one user equipment; and a core network.

In one embodiment, the processing data packets using the simulation comprises processing user plane traffic at the simulation of the at least one radio access point but not the simulation of the at least one user equipment.

In one embodiment, the apparatus is configured to: prior to the processing of the one or more data packets, receive the one or more data packets from the network server apparatus.

In one embodiment, the apparatus is configured to: following the processing of the one or more data packets, send the one or more data packets to the network server apparatus.

In one embodiment, the apparatus is configured to: process by the testing apparatus, the one or more data packets using simulations of a plurality of radio access point and a plurality of user equipments.

According to a fourth aspect, there is provided an apparatus comprising: means for processing by a testing apparatus, one or more data packets using simulations of at least one of: at least one radio access point and at least one user equipment; and a core network, wherein the one or more data packets comprises at least one of: one or more data packet received from the network server apparatus; and one or more data packets to be transmitted to the network server apparatus.

### BRIEF DESCRIPTION OF FIGURES

Some embodiments will now be described in further detail, by way of example only, with reference to the following examples and accompanying drawings, in which:

FIG. 1 shows a schematic example of a wireless communication system where some embodiments may be implemented;

FIG. 2 shows an example of a communication device;

FIG. 3 show an example of a communication system;

FIG. 4 show an example of a communication system;

FIG. 5 shows an example user plane protocol structure;

FIG. 6 shows an example control plane protocol structure;

FIG. 7 shows an example of a user plane protocol structure;

FIG. 8 shows an example of a control plane protocol structure;

FIG. 9 illustrates an example method;

FIG. 10 shows an example control apparatus; and

FIG. 11 shows an example of a non-transitory computer readable medium.

### DETAILED DESCRIPTION

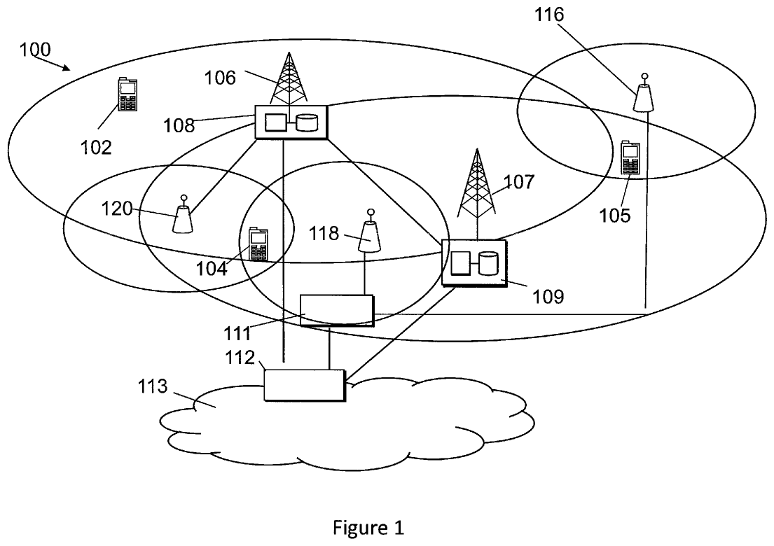

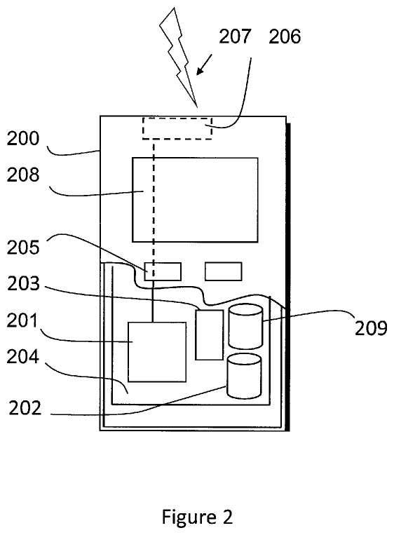

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, wireless communication devices, for example, user equipment (UE) or Machine Type-Communication (MTC) devices 102, 104, 105 are provided wireless access via at least one base station or similar wireless transmitting and/or receiving wireless infrastructure access node or point. Such an access node can be, for example, a base station or an eNodeB (eNB), or in a 5G system a Next Generation NodeB (gNB), or other wireless infrastructure node. These nodes will be generally referred to as base stations. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1, control apparatus 108 and 109 are shown to control the respective macro level base stations 106 and 107. In some systems, the control apparatus may additionally or alternatively be provided in a radio network controller. Other examples of radio access system comprise those provided by base stations of systems that are based on technologies such as 5G or new radio, wireless local area network (WLAN) and/or WiMax (Worldwide Interoperability for Microwave Access). A base station can provide coverage for an entire cell or similar radio service area.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided.

A possible wireless communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication, for example being a MTC device. In the present teachings the terms UE is used but it should be appreciated that embodiments may be used with any type of wireless communication device.

The wireless device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the wireless device.

A wireless device is typically provided with at least one data processing entity 201, at least one random access memory 202, at least one read only memory 209, and other possible components 203 for use in software and hardware aided execution of tasks it is designed to perform, including control of access to and communications with access systems and other communication devices. The at least one random access memory 202 and the at least one read only memory 209 may be in communication with the data processing entity 201, which may be a data processor. The data processing, storage and other relevant control apparatus can be provided on an appropriate circuit board and/or in chipsets. This feature is denoted by reference 204. The user may control the operation of the wireless device by means of a suitable user interface such as key pad 205, voice commands, touch sensitive screen or pad, combinations thereof or the like. A display 208, a speaker and a microphone can be also provided. Furthermore, a wireless communication device may comprise appropriate connectors (either wired or wireless) to other devices and/or for connecting external accessories, for example hands-free equipment, thereto. The communication devices 102, 104, 105 may access the communication system based on various access techniques.

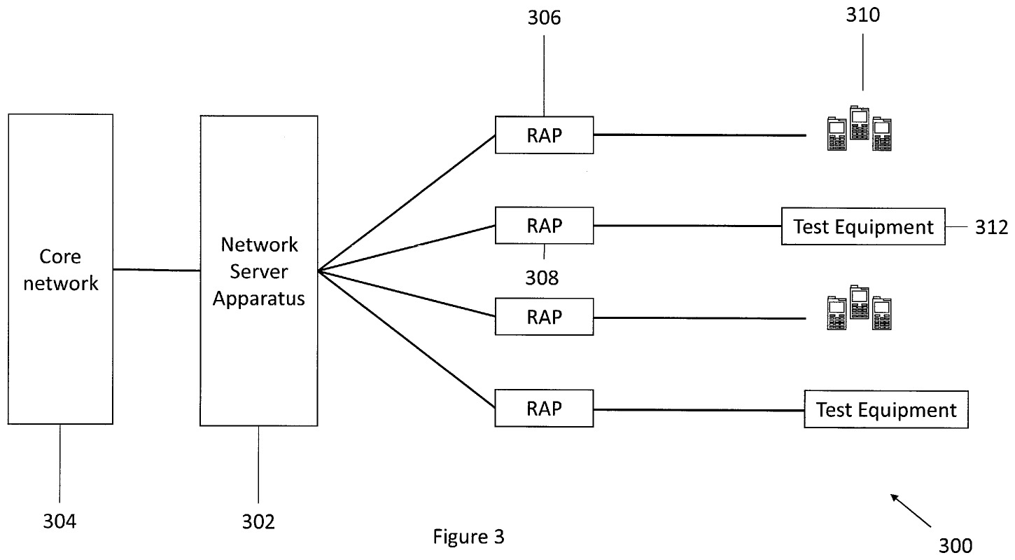

Reference is made to FIG. 3, which shows a communication system 300 having a network server apparatus 302. The network server apparatus 302 may be part of a cloud base transceiver station or similar network apparatus. The network server apparatus may comprise a virtual network function to be tested. The network server apparatus may comprise a single server or a set of servers that are distributed from one another. The network server apparatus may be provided in a data centre or a set of distributed data centres. The communication system 300 is shown in a configuration that may be used to perform testing of the network server apparatus.

In some examples, the network server apparatus 302 may be configured to communicate with a core network 304 of the communication system 300. The core network 304 comprises a number of core network nodes of the communication system 300. The core network 304 may be an evolved packet core. The core network 304 may comprise a mobility management entity (MME). The MME is the key control-node for the LTE access-network. The MME manages session states and authenticates and tracks a user across the network. It is responsible for the idle mode UE paging and tagging procedure including retransmissions. It is involved in the bearer activation/deactivation process and is also responsible for choosing the serving gateway for a UE at the initial attach and at time of intra-LTE handover involving Core Network (CN) node relocation. It is responsible for authenticating the user by interacting with the home subscriber server (HSS) of the evolved packet core. The HSS, which is also part of the evolved packet core, is a central database that contains user-related and subscription-related information. The functions of the HSS include functionalities such as mobility management, call and session establishment support, user authentication and access authorisation. The core network 304 may also include a gateway which transports traffic between the communication system and external networks. The gateway may be a packet data network (PDN) gateway, which is configured to transport IP data traffic between the internet and the communication system 300. In other examples, the network server apparatus 302 may be configured to communicate with a different core network instead of an evolved packet core 304.

The network server apparatus 302 may be configured to communicate with one or more radio access points (labelled as ‘RAP’ in FIG. 3). In the field of wireless computer networking, a radio access point is a radio receiver/transmitter that serves one or more devices of a local wireless network. Such an access point may provide access to a wireless network, to UEs, by communicating with the UEs via radio communication. The access point may comprise at least one antenna used to send and receive radio waves for communication with such UEs. The communications may be in accordance with a communication protocol, such as those developed by 3GPP or the Wi-Fi alliance. In the case of a router used for internet access, the access point may then communicate with an internet service provider to provide internet access to the UEs in its vicinity. Each access point may comprise at least one remote radio head.

A first radio access point 306 is configured to communicate with one or more UEs 310. The first radio access point 306 is configured to provide access to a network, such as the internet for the UEs 310. The first radio access point 306 may be configured to exchange data packets between the UEs 310 and the network server apparatus 302.

During normal operation each radio access point may be configured to communicate with UEs which are within its vicinity. During testing operation of the network server apparatus, the radio access points may also communicate with UEs in the vicinity for testing purposes. It may be necessary for data transfer between the UEs 310 and the network server apparatus 302 and between the network server apparatus 302 and the core network 304 to be carried out for the purposes of testing aspects of the network server apparatus. For example, the data exchange may be carried out for the purposes of providing load testing of the network server apparatus 302. Load testing is the process of putting demand on the network server apparatus and measuring its response, for the purpose of determining a system's behaviour under both normal and anticipated peak load conditions. Additionally or alternatively, data exchange between the network server apparatus 302 and other elements of the communication system may be carried out for the purposes of providing performance testing of the network server apparatus 302. A performance test is any test that measures stability, performance, scalability and/or throughput of the network server apparatus 302. Additionally or alternatively, data exchange between the network server apparatus 302 and other elements of the communication system 300 may be carried out for the purposes of providing capacity testing of the network server apparatus 302. A capacity test is a test to determine how many UEs a network server apparatus can manage and be in communication with before either performance or stability becomes unacceptable. By knowing the number of UEs the network server apparatus can manage, better visibility into events that might push the network server apparatus beyond its limitations may be obtained. Additionally or alternatively data exchange between the network server apparatus 302 and other elements of the communication system may be carried out for the purposes of providing stability testing of the network server apparatus 302. In stability testing, the aim is to stress the network server apparatus 302 to the maximum to determine how well it performs under loads at acceptable levels, peak loads, load generated in spikes, with a large number of volumes data to be processed, etc. Stability testing is done to check the efficiency of a developed product beyond normal operational capacity, often to a breakpoint. Compared to other forms of testing, there is greater significance placed on error handling, reliability, robustness and scalability of the network server apparatus 302 under heavy load rather than checking the system behaviour under normal circumstances.

During testing, some UEs may be replaced with specialised testing equipment. The radio access point 308, for example, is configured to communicate with testing equipment 312. The testing equipment 312 could, for example, provide scalable testing for validating network performance. The testing equipment 312 may replicate the behaviour of real UEs, such as web browsing, emails, downloading files, video streaming, and voice over LTE (VoLTE), together with mobility across the radio network. The testing equipment 312 may also provide measurement of the performance of the network.

One problem is that there are some network server apparatus that may require large numbers of radio access points and UEs in order to carry out the testing discussed above. For example, if the network server apparatus is cloud base transceiver station 17, a maximum of 62 radio access points, covering 256 cells and serving 100,000 UE are supported. The target throughput being 10 Gigabits per second in the downlink and 6 Gigabits per second in the uplink. To achieve such a large number of radio access points and UEs as well as a high throughput is a challenge. In such a testing environment, a huge amount of resources, space, and power are required to achieve these targets. It may be a challenge to the UEs, such as UEs 310, and to any testing equipment in communication with radio access points, such as test equipment 312. The amount of capacity and performance required of elements of the communication system is also a challenge for the core network 304. The demands on a core network 304 to support the maximum number of UEs and the peak throughput required to perform testing on the network server apparatus 302 may be too high. This problem may become accentuated in the future, as future cloud base transceiver station releases many have an even higher capacity to support devices (e.g. millions of UEs), and an even higher peak throughput. Attempting to perform testing with such high demands, may place too high a demand on the remaining equipment in the communication system (i.e. radio access points, core network, UEs, test equipment).

The inventors have thus identified a problem, which is to develop a means of testing network server apparatus that is capable of providing the large capacity and throughput that may be required for testing.

Embodiments of the application provide a testing apparatus that provides a simulation of one or more radio access points and one or more UEs and/or provides a simulation of the core network testing apparatus The testing apparatus may send and receive traffic from the network server apparatus, in such a way so as to appear to the network server apparatus as one or more radio access points and one or more UEs. Therefore, a number of radio access points and UEs may be replaced by the testing apparatus during testing, so that the demands that need to be met by the equipment of the communication system during testing of the network server apparatus may be met by the testing apparatus. In some embodiments, the testing may be configured to provide a simulation of a core network, such as an evolved packet core. The testing apparatus may send and receive traffic from the network server apparatus, in such a way so as to appear to the network server apparatus as a core network. Therefore, communications with the core network during testing may be replaced by communications with the testing apparatus during testing, so that the demands that need to be met by the core network of the communication system during testing of the network server apparatus may be met by the testing apparatus instead. In some embodiments, the testing apparatus may provide a simulation of one or more radio access points, one or more UEs and a core network. The testing apparatus may send and receive traffic from the network server apparatus, in such a way so as to appear to the network server apparatus as representing all three of: one or more radio access points, one or more UEs and a core network.

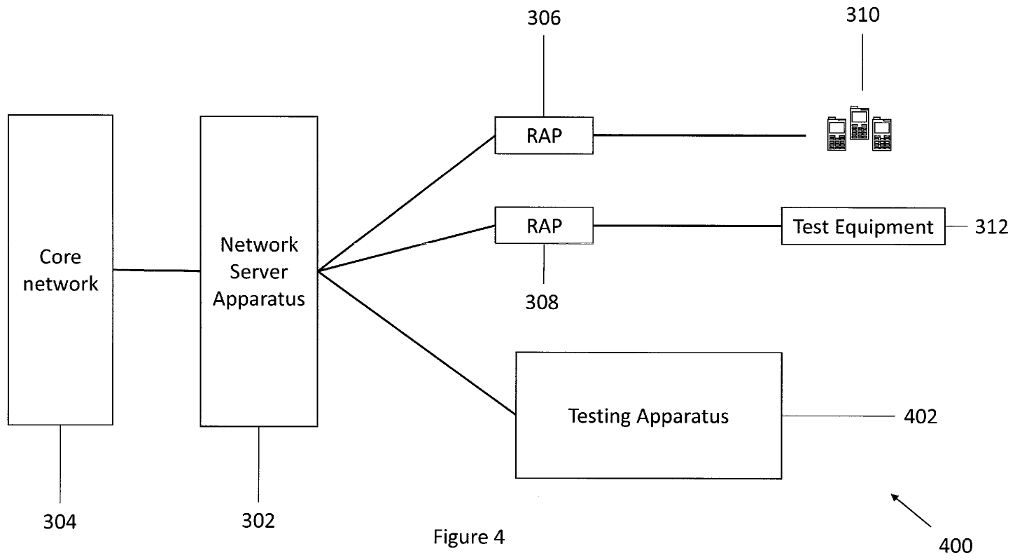

Reference is made to FIG. 4, which shows a communication system 400 according to embodiments of the application. The communication system 400 includes a network server apparatus 302, which may the same as the network server apparatus 302 described above with respect to FIG. 3. The communication system 400 may also include a core network 304, radio access points 306, 308, UE 310 and test equipment 312, which may be substantially the same as the corresponding elements described above with respect to FIG. 4. The communication system 400 also includes testing apparatus 402. The testing apparatus 402 may replace one or more radio access points, and one or more UEs and communicate with the network server apparatus 302 so as to simulate the behaviour of those replaced one or more radio access points. In some embodiments, the testing apparatus 402 may replace all of the radio access points and UEs during testing. The testing apparatus 402 may provide a simulation of up to the maximum number of UEs that the network server apparatus 302 is configured to communicate with. In other embodiments, as shown in FIG. 4, some radio access points 306, 308, UE 310, and test equipment 312 may send and receive data from the network server apparatus 302 during testing for testing purposes as well as the network server apparatus 302 sending and receiving data from the testing apparatus 402 for testing purposes. Some radio access points and UE may be retained and communicate with the network server apparatus 302 during functional test cases. However, in capacity, performance and load test cases, no radio access points and UEs may be in communication with the network server apparatus, with all of them may being replaced by the testing apparatus.

In some embodiments, the testing apparatus 402 may provide a simulation of the core network 304. This simulation may be in addition to or instead of the simulations provided by the testing apparatus 402 of the one or more radio access points and one or more UEs. Although in FIG. 4, the network server apparatus is shown in communication with the core network 304, in some embodiments the communications with the testing apparatus 402 may replace the communications with the core network 304 during testing of the network server apparatus. The simulation of the core network may provide communications according to the maximum capacity (i.e. number of UEs) and maximum throughput to the network server apparatus.

In some embodiments, the testing apparatus 402 may providing by one or more servers that are separate from the network server apparatus 302, but configured to communicate with the network server apparatus 302. In other embodiments, the testing apparatus 402 may be provided by the same server or one or more of a plurality of servers that provide the network server apparatus 302. In this case, the network server apparatus 302 and testing apparatus 402 may both be provided by software in one or more servers. The testing apparatus 402 may be provided a cloud server hardware, with the testing function being provided by server virtualisation in the cloud server hardware. The simulators of the testing apparatus 402 may be provided on a cloud server virtual machine. This may be advantageous for the test environment, management, elasticity and capacity expansion. The cloud server may also provide the network server apparatus 302.

The testing apparatus 402 may be deployed on one cloud server (using server virtualisation) or multiple cloud servers for capacity extension. The testing function can simulate a number of UE connections with high throughput towards the network server apparatus.

Some equipment that may be used for testing, e.g. UEs 310, test equipment 312, and radio access point 306, 308, will implement a full protocol stack that is used for processing data sent and received from the network server apparatus 302. Processing data packets at every layer of a full protocol stack may be complicated and resource consuming for a radio access point in the case of a large number of UEs and a high throughput requirement. Such a radio access point when communicating with a large number of UEs may have to perform protocol processing which places heavy demands on its processing resources. Furthermore, heavy demands may be placed on the UEs themselves due to the high throughput requirement. Processing at certain layers of the protocol stack, such as L1/PHY in Air interface, may produce a capacity and performance bottleneck in test environments with real equipment (e.g. radio access points 306, 308, UEs 310 or test equipment 312). As will be explained with reference to the following figures, embodiments may address this issue by reducing the number of layers at which protocol processing must be performed in the simulation of parts of equipment of a communication system.

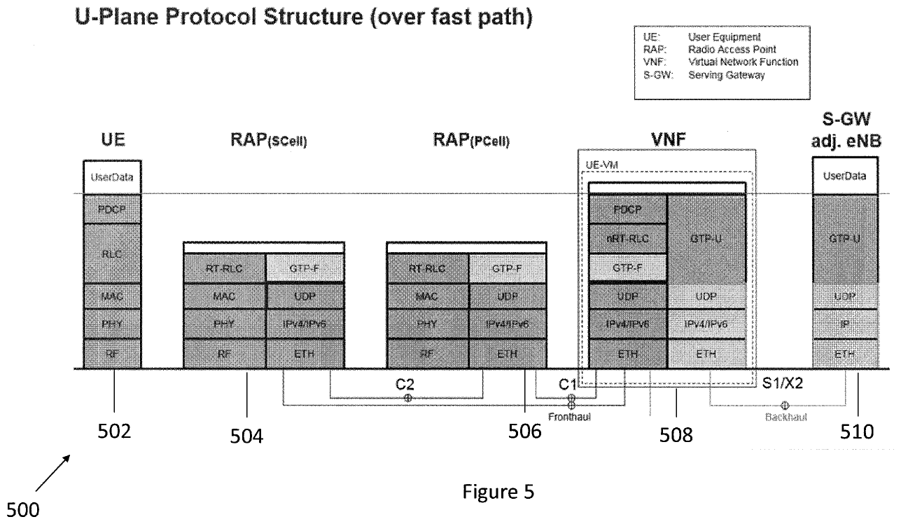

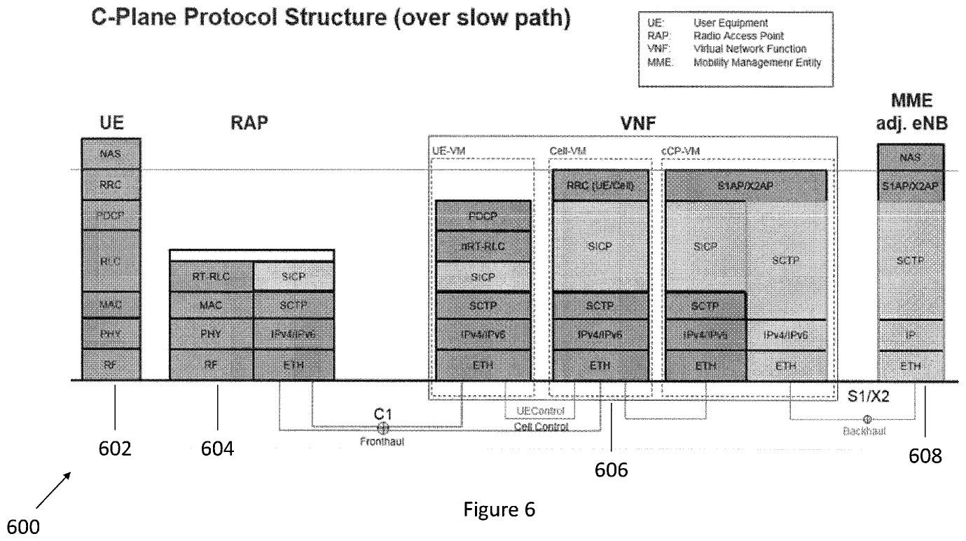

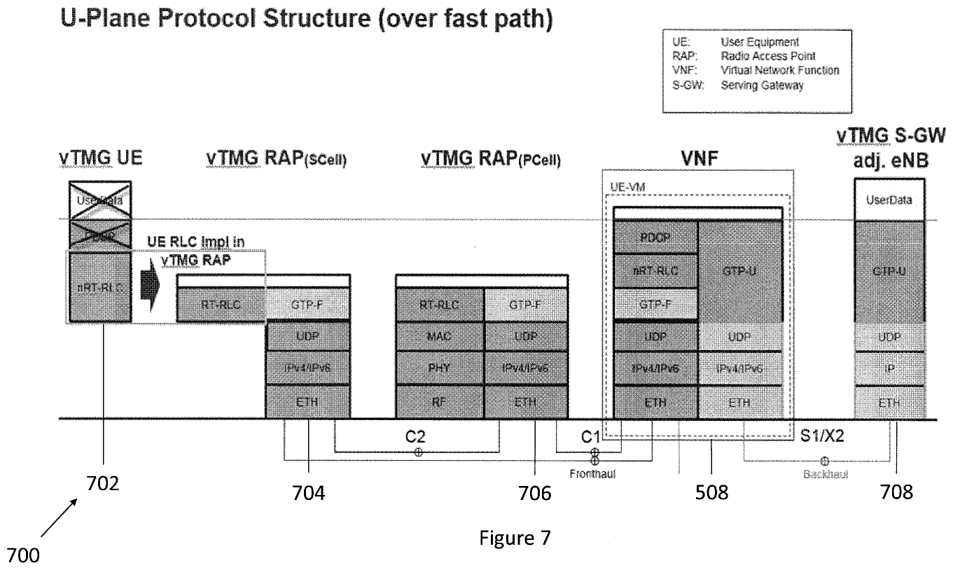

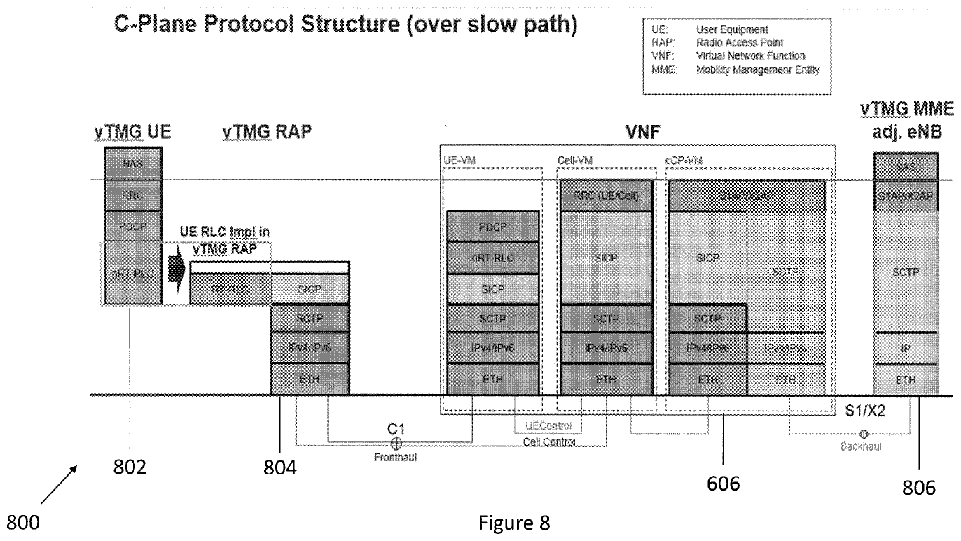

Reference will now be made to FIGS. 5 to 8, which show examples of the protocol stack that may be implemented in communication systems. FIGS. 5 and 6 show user plane and control plane protocol structures that may implemented in a communication system 300 as shown in FIG. 3. FIGS. 7 and 8 show user plane and control plane protocol structures that may be implemented in a communication system 400 as shown in FIG. 4.

Reference is made to FIG. 5, which shows an example user plane protocol structure that may be implemented in a communication system 300 as shown in FIG. 3. FIG. 5 shows an example of a protocol stack 502 that may be implemented in a UE, such as one of UEs 310. The protocol stack 502 may include a UserData layer, a Packet Data Convergence Protocol layer, a Media Access Control Layer, a Radio link control layer, a physical layer, and a radio frequency layer. FIG. 5 also shows an example of a protocol stack 504 that may be implemented in a radio access point of a secondary cell. The protocol stack 504 may include a Radio link control layer, a Media Access Control Layer, a physical layer, a Radio Frequency layer, a General Packet Radio Service Tunneling Protocol layer, a User Datagram Protocol layer, an Internet protocol layer, and an Ethernet layer. FIG. 5 also shows an example of a protocol stack 506 that may be implemented in a radio access point of a primary cell. The protocol stack 506 may include the same layers as the protocol stack 504 implemented in the radio access point of the secondary cell. FIG. 5 also shows an example of a protocol stack 508 that may be implemented in the network server apparatus 302. The protocol stack of the network server apparatus 302 is shown in this example as being part of a virtual network function. The protocol stack 508 may include a Packet Data Convergence Protocol layer, a Radio link control layer, a General Packet Radio Service Tunneling Protocol layer, a User Datagram Protocol layer for communicating with a radio access point, an internet protocol layer for communicating with a radio access point, an Ethernet layer for communicating with a radio access point, an internet protocol layer for communicating with a core network node, an Ethernet layer for communicating with a core network node, and a User Datagram Protocol layer for communicating with a core network node. FIG. 5 also shows an example of protocol stack 510 that may be implemented in serving gateway of the core network 304. The protocol stack 510 may include a UserData layer, a General Packet Radio Service Tunneling Protocol layer, a User Datagram Protocol layer, an internet protocol layer, an Ethernet layer. It would be appreciated that this protocol structure is an example only, and that other protocol structures may be implemented in such a communication system 300.

Reference is made to FIG. 6, which shows an example control plane protocol structure that may be implemented in a communication system 300 as shown in FIG. 3. FIG. 6 shows an example of a protocol stack 602 that may be implemented in a UE, such as one of UEs 310. The protocol stack 602 may include a Non-access stratum layer, Radio Resource Control layer, a Packet Data Convergence Protocol layer, a Radio link control layer, a Media Access Control Layer, a physical layer, and a radio frequency layer. FIG. 6 also shows an example of a protocol stack 604 that may be implemented in a radio access point, such as radio access point 604. The protocol stack 604 may include a Radio Link control layer, a Media Access Control Layer, a physical layer, a Radio Frequency layer, a Stream Control Transmission Protocol layer, an Internet protocol layer, and an Ethernet layer. FIG. 6 also shows an example of a protocol stack 606 that may be implemented in a network server apparatus 302. The protocol stack 606 may include a Packet Data Convergence Protocol layer, a Radio Link Control layer, a Stream Control Transmission Protocol layer, an Internet protocol layer, an Ethernet layer, a Radio Resource Control layer, an S1 Application Protocol layer, and an X2 Application Protocol layer. FIG. 6 also shows an example of a protocol stack 608 that may be implemented in a Mobility Management Entity of a core network 304. The protocol stack 608 may include a Non-access stratum layer, an S1 Application Protocol layer, an X2 Application Protocol layer, a Stream Control Transmission Protocol layer, an Internet Protocol layer, and an Ethernet layer. It would be appreciated that this protocol structure is an example only, and that other protocol structures may be implemented in such a communication system 300.

During operation of the communication system 300, data packets must be processed at the different layers of protocol stacks, such as stacks shown in FIG. 5 and FIG. 6. It would be advantageous to reduce the amount of protocol processing required by the communication system 300 when performing testing of the network server apparatus 302. Embodiments of the application may reduce the number of layers of the protocol stacks as illustrated by the examples shown in FIGS. 7 and 8.

Reference is made to FIG. 7, which shows an example user plane protocol structure 700 that may be implemented in a communication system 400 as shown in FIG. 4. FIG. 7 shows a protocol stack 508 of the network server apparatus 302, which may be the same as the protocol stack implemented in the network server apparatus 302 of the communication system 300 and described above with respect to FIG. 5. FIG. 7 shows a protocol stack 708 that may be implemented in the testing apparatus 402. The processing carried out for data packets using protocol stack 708 may be part of the simulation of the core network provided by the testing apparatus 402. The protocol stack 708 may be the same as the protocol stack 510 for the serving gateway of the protocol structure 500. FIG. 7 shows a protocol stack 706 that may be implemented in the testing apparatus 402. The processing carried out for data packets using protocol stack 706 may be part of the simulation of the radio access point provided by the testing apparatus 402. The protocol stack 706 may be the same as the protocol stack 506 for the radio access point of the primary cell of the protocol structure 500. FIG. 7 shows a protocol stack 704 that may be implemented in the testing apparatus 402. The processing carried out for data packets using protocol stack 704 may correspond to the processing carried out by a radio access point of a secondary cell in the communication system 300 and illustrated by protocol stack 504. However, the testing apparatus 402 may omit processing at one or more layers of the protocol stack 804. For example, the protocol stack 704 may omit the Media Access Control Layer, Physical Layer, and the Radio Frequency layer that are present in the protocol stack 504. The testing apparatus 402 is able to omit these layers from the protocol stack 704 whilst still providing an accurate simulation of the radio access points to the network server apparatus 302, since these layers are also omitted from the protocol stack 702 of the simulation of the UE. Since these layers are used for packaging and unpackaging real data packets transmitted between a radio access point and a UE, they are not needed to provide an accurate simulation of a radio access point and a UE from the perspective of the network server apparatus 302. Therefore, it is possible to omit them from the protocol structure of the testing apparatus. FIG. 7 shows the protocol stack 702 that may be implemented in the testing apparatus 402. The processing carried out for data packets using protocol stack 702 may correspond to the processing carried out by a UE in the communication system 300 and illustrated by protocol stack 502. The protocol stack may comprise a Radio Link Control Layer. As explained above, one or more protocol layers that are present in the protocol stack 502 of the UE may be omitted from the protocol stack 702 of the testing apparatus' simulation of the UE. These may include the Media Access Control Layer, Physical Layer, and the Radio Frequency layer, and also the UserData layer and Packet Data Convergence Protocol Layer. Since the uplink and downlink user data are fake data generated by simulators, so processing of the user data may be omitted, thereby saving hardware resources in the user plane.

Reference is made to FIG. 8, which shows an example control plane protocol structure 800 that may be implemented in a communication system 400 as shown in FIG. 4. In the control plane, the simulated radio access point and simulated UE may use a simple messaging protocol, e.g. based on TCP/IP for communication between them, so as to pass packet data convergence protocol data, radio resource control data, and Non-access stratum layer. FIG. 8 shows a protocol stack 606 of the network server apparatus 302, which may be the same as the protocol stack 606 implemented in the network server apparatus 302 of the communication system 300 and described above with respect to FIG. 6. FIG. 8 shows a protocol stack 804 that may be implemented in the testing apparatus 402. The processing carried out for data packets using protocol stack 806 may be part of the simulation of the core network provided by the testing apparatus 402. The protocol stack 806 may be the same as the protocol stack 608 for the Mobility Management Entity of the core network 304. FIG. 8 shows a protocol stack 804 that may be implemented in the testing apparatus 402. The processing carried out for data packets using protocol stack 804 may correspond to the processing carried out by a radio access point in the communication system 300 and illustrated by protocol stack 604. However, the testing apparatus 402 may omit processing at one or more layers of the protocol stack 804. For example, the protocol stack 804 may omit the Media Access Control Layer, Physical Layer, and the Radio Frequency layer that are present in the protocol stack 604. The testing apparatus 402 is able to omit these layers from the protocol stack 804 whilst still providing an accurate simulation of the radio access points to the network server apparatus 302, since these layers are also omitted from the protocol stack 802 of the simulation of the UE. Since these layers are used for packaging and unpackaging real data packets transmitted between a radio access point and a UE, they are not needed to provide an accurate simulation of a radio access point and a UE from the perspective of the network server apparatus 302. Therefore, it is possible to omit them from the protocol structure of the testing apparatus 402. FIG. 8 shows the protocol stack 802 that may be implemented in the testing apparatus 402. The processing carried out for data packets using protocol stack 802 may correspond to the processing carried out by a UE in the communication system 300 and illustrated by protocol stack 602. The protocol stack may comprise a Non-access stratum layer, a Radio Resource Control Layer, a Packet Data Convergence Protocol Layer, and a Radio Link Control Layer. As explained above, one or more protocol layers that are present in the protocol stack 602 of the UE may be omitted from the protocol stack 802 of the testing apparatus' simulation of the UE. These may include the Media Access Control Layer, Physical Layer, and the Radio Frequency layer.

It would be understood by the skilled person, that when the description states that one or more protocol layers are omitted from the simulations, this may be taken to mean that data packets are not processed at these layers, even if the testing apparatus may retain the capability to do so.

In some examples, part of the protocol processing that is implemented in a real UE may be carried out in the simulated radio access point. For example, the Radio Link Control layer which is part of the protocol stack 702 and the protocol stack 802 shown in FIGS. 7 and 8, may be moved to the protocol stack 704 and protocol stack 804, respectively. This may move the Radio Link Control layer processing of the UE to the simulation of the Radio Link Control layer, so that radio link control layer processing is performed in the simulation of the radio access point. This may help to achieve architecture and performance optimisation.

By performing the Radio Link Control layer processing in the simulated radio access point, downlink user plane traffic that is sent from a core network 304 via the network server apparatus to the simulated radio access point, may terminate at the simulated radio access point, with there being no need to forward the downlink user plane traffic to the simulated UE. The simulated radio access point may also perform the sending of radio link control layer acknowledgements (RLC ARQ) for data packets received from the network server apparatus instead of the UE.

Furthermore, by performing the Radio Link Control layer processing in the simulated radio access point, uplink user plane traffic that is to be sent to the network server apparatus may be generated at radio access point rather than at the UE.

The testing apparatus, which provides at least one of simulated UEs and a simulated core network, may be lightweight L3 and control plane equipment. It means that only necessary part of the radio resource control and Non-access stratum protocols need be implemented. The simulated UE and simulated core network may simplify the attach and detach procedures (as no real core network is involved) to minimise the implementation efforts.

The attachment and detachment of a simulated UE towards a simulated core network can be achieved by using a specific UE public land mobile network for simulated UE. Then the network server apparatus may identify and route communications from a simulated UE to a simulated core network, and communications from a real UE to a real core network.

Therefore, as illustrated by FIGS. 5 to 8, embodiments of the application include omitting processing at one or more layers of a protocol stack in simulation of a UE by the testing apparatus that are present in a real UE that is being simulated. Embodiments of the application also may include omitting processing at one or more layers of a protocol stack in a simulation of a radio access point by the testing apparatus that are present in a real radio access point that is being simulated. In some embodiments, the layers omitted in the simulation of the radio access point and the UE may be the same. Hence, by combining the simulations of the radio access point and the UE, not all of the protocol stack of a radio access point and a UE is needed, and the resources required to perform the necessary protocol processing may be reduced. For example, the physical link layer and medium access control layers of the protocol stack may be bypassed in the simulations of the UEs and radio access nodes, so that certain capacity and performance bottlenecks are removed.

It should be appreciated that the protocol structures presented in FIGS. 5 to 8 are examples only, and that other protocol structures may be implemented in a network server apparatus, a test function, a real UE, a real radio access point and a real core network.

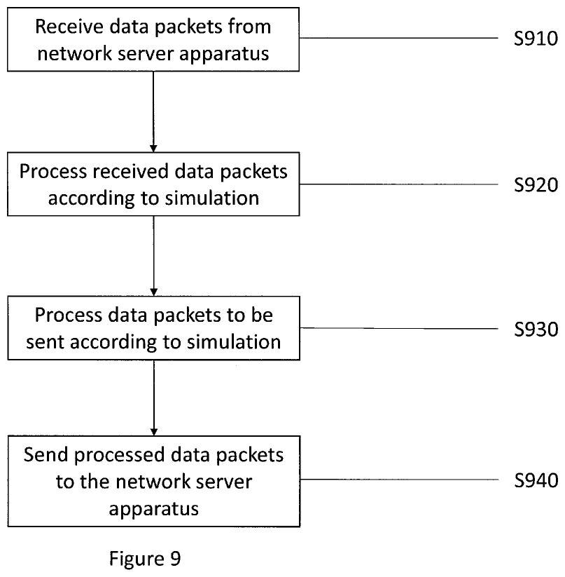

Reference is made to FIG. 9, which shows an example of a method that may be performed by a testing apparatus 402. It is understood by the skilled person that not all of these steps are essential, and that one or more of them may be omitted. At S910, the testing apparatus receives one or more data packets. The one or more data packets may be received from the network server apparatus 302. The one or more data packets may be received from another part of the testing apparatus that is configured to generate the one or more data packets (e.g. to simulate uplink traffic from a UE).

At S920, the testing apparatus is configured to process each of the one or more data packets according to a simulation of at least one of: a core network; and a radio access point and UE (e.g. processing in accordance with an operating communication protocol). In other words, at least some of the processing functions performed by those entities during communications of the one or more data packets are simulated by the testing apparatus alone. The processing may comprise protocol processing. The protocol processing by a simulated radio access point and UE may comprise processing using a reduced protocol stack. The reduced protocol stack may omit layers present in the protocol stacks of real versions of the UE and radio access node. The processing may comprise analysing the received one or data packets to obtain testing data related to the network server apparatus. For example, the one or more data packets may be analysed for the purposes of capacity testing, load testing or performance testing of the network server apparatus. The testing data produced from processing the one or more data packets may comprise parameters indicating the performance of the network server apparatus under different conditions.

At S930, the testing apparatus 402 is configured to process one or more data packets for sending to the network server apparatus 302. These one or more data packets may be sent in response to the one or more data packets received at S910. The processing performed at S930 comprises processing each of the one or more data packets according to a simulation of at least one of: a core network; and a radio access point and UE. The processing may comprise protocol processing. The protocol processing by a simulated radio access point and UE may comprise processing using a reduced protocol stack. The reduced protocol stack may omit layers present in the protocol stacks of real versions of the UE and radio access node.

At S940, in response to processing the one or more data packets at S930, the testing apparatus 402 is configured to send the processed one or more data packets to the network server apparatus 302.

In some cases, the testing apparatus may be said to act as a message sink, and the steps S930, and S940 may be omitted. In this case, the testing apparatus may receive one or more data packets and process the data packets, without sending a response. For example, the testing apparatus may be configured to operate like this when receiving one or more data packets from the network server apparatus in RLC unacknowledged mode. In some cases, the steps S910, and S920 may be omitted, and the testing apparatus may be configured top process and send one or more data packets without receiving a response from the network server apparatus. Such unidirectional communication may occur for uplink and downlink user plane traffic. In some cases the communication may be bidirectional, and the testing apparatus may perform all of the steps of the method shown in FIG. 9. This may be carried out for control plane traffic and also for some user plane traffic (such as RLC acknowledged mode traffic).

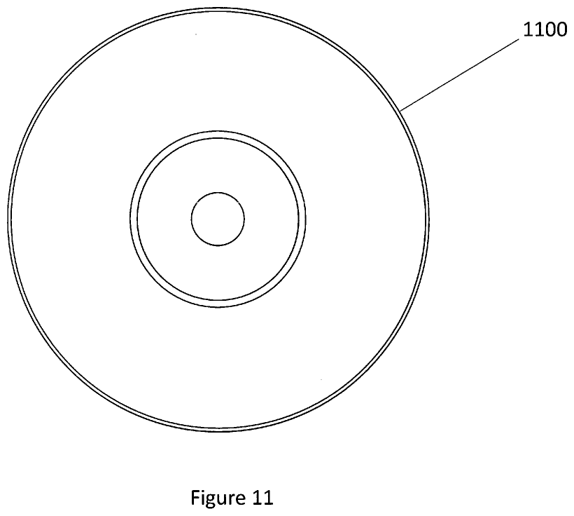

The method according to embodiments of the application may be implemented in a computer program. A computer program may comprise instructions such that when the computer program is executed on a computing device, e.g. the testing apparatus, the computing device performs the method according to embodiments of the application. A computer program may be configured to provide simulations of at least one of: at least one radio access point and at least one user equipment; and a core network. A computer program may be configured to provide the generation of traffic to send to the network server apparatus. A computer program may be configured to receive and process traffic from the network server apparatus. Any such computer program may be stored on a non-transitory computer readable medium. An example of a non-transitory computer readable medium 1100 is shown in FIG. 11. The non-transitory computer readable medium 1100 may be a CD or DVD.

It is noted that whilst embodiments have been described in relation to one example of a standalone LTE network, similar principles maybe applied in relation to other examples of standalone 3G, LTE or 5G networks. It should be noted that other embodiments may be based on other cellular technology other than LTE or on variants of LTE. It should also be noted that other embodiments may be based on standards other than NB-IoT or on variants of NB-IoT. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

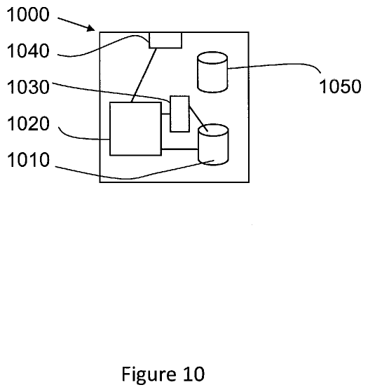

The method may additionally be implemented in a control apparatus as shown in FIG. 10. The method may be implemented in a single processor 201 or control apparatus or across more than one processor or control apparatus. FIG. 10 shows an example of a control apparatus 1000 for a communication system, for example to be coupled to and/or for controlling a station of an access system, such as a RAN node, e.g. a base station, (e) node B, a central unit of a cloud architecture or a node of a core network such as an MME or S-GW, a scheduling entity such as a spectrum management entity, or a server or host. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 1000 can be arranged to provide control on communications in the service area of the system. The control apparatus 1000 comprises at least one random access memory 1010, at least one read only memory 1050, at least one data processing unit 1020, 1030 and an input/output interface 1040. The at least one random access memory 1010 and the at least one read only memory 1050 are in communication with the at least one data processing unit 1020, 1030. Via the interface the control apparatus can be coupled to a receiver and a transmitter of the base station. The receiver and/or the transmitter may be implemented as a radio front end or a remote radio head. For example, the control apparatus 1000 or processor 201 can be configured to execute an appropriate software code to provide the control functions.

Control functions may comprise: causing processing by a testing apparatus, one or more data packets using simulations of at least one of: at least one radio access point and at least one user equipment; and a core network, wherein the one or more data packets comprises at least one of: one or more data packet received from the network server apparatus; and one or more data packets to be transmitted to the network server apparatus.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1-16. (canceled)

17. A method comprising: processing by a testing apparatus, one or more data packets using simulations of at least one of:
at least one radio access point and at least one user equipment; and
a core network,
wherein the one or more data packets comprises at least one of:
one or more data packet received from the network server apparatus; and
one or more data packets to be transmitted to the network server apparatus.

18. A method as claimed in claim 17, wherein the network server apparatus is part of a base transceiver station server.

19. A method as claimed in claim 18, wherein the testing apparatus is part of the base transceiver station server.

20. A method as claimed in claim 17, wherein the processing of the one or more data packets comprises protocol processing the one or more data packets.

21. A method as claimed in claim 20, wherein the protocol processing of the one or more data packets comprises protocol processing using a protocol stack of the simulation of at least one radio access point and a protocol stack of the simulation of at least one user equipment.

22. A method as claimed in claim 21, wherein at least one of the protocol stacks does not perform processing for the data packets at one or more layers that are present in the protocol stacks of a real user equipment and a real radio access point.

23. A method as claimed in claim 20, wherein at least one of the protocol stacks does not perform processing for the data packets at least one of: a Packet data convergence protocol layer; a user data layer; a medium access control layer; a physical layer; and a radio frequency layer.

24. A method as claimed in claim 21, wherein the protocol stack of the simulation of at least one radio access node performs at least some of the processing performed by a protocol stack of a real user equipment instead of the protocol stack of the simulation of the user equipment.

25. A method as claimed in claim 24, wherein the at least some of the processing performed by a protocol stack of a real user equipment comprises radio link control layer processing.

26. A method as claimed in claim 17, wherein the testing apparatus comprises a simulation of: at least one radio access point and at least one user equipment; and a core network.

27. A method as claimed in claim 17, wherein the processing data packets using the simulation comprises processing user plane traffic at the simulation of the at least one radio access point but not the simulation of the at least one user equipment.

28. A method as claimed in claim 17, comprising: prior to the processing of the one or more data packets receiving the one or more data packets from the network server apparatus.

29. A method as claimed in claim 17, comprising: following the processing of the one or more data packets, sending the one or more data packets to the network server apparatus.

30. A method as claimed in claim 17, comprising: processing by the testing apparatus, the one or more data packets using simulations of a plurality of radio access points and a plurality of user equipments.

31. A computer program comprising instructions such that when the computer program is executed on a computing device, the computing device is arranged to perform the steps of claim 17.

32. An apparatus comprising:
at least one processor and at least one memory including computer program code, the at least one memory and the computer program code configured to, with the at least one processor, cause the apparatus at least to:
process by a testing apparatus, one or more data packets using simulations of at least one of:
at least one radio access point and at least one user equipment; and
a core network,
wherein the one or more data packets comprises at least one of:
one or more data packet received from the network server apparatus; and
one or more data packets to be transmitted to the network server apparatus.
